(19) United States
(12) Patent Application Publication
(10) Pub. No.: US 2026/0275876 A1
(43) Pub. Date: Sep. 17, 2026

(54) Guide Vane Segment

(71) Applicant: MTU Aero Engines AG, München (DE)

(72) Inventor: Dennis VON BRAUNECK, Munich (DE)

(73) Assignee: MTU Aero Engines AG, München (DE)

(21) Appl. No.: 19/051,282

(22) Filed: Feb. 12, 2025

(30) Foreign Application Priority Data
Feb. 16, 2024 (DE) 10 2024 104 404.7

(51) Int. Cl. F01D 9/04

(52) U.S. Cl. CPC F01D 9/042; F01D 9/041; F04D 29/542; F01D 11/08; F01D 25/246; F05D 2240/11; F05D 2240/80; F05D 2260/36; F05D 2260/941

(57) ABSTRACT

The invention relates to a guide vane segment for a flow channel in a compressor of an aircraft engine as well as to an aircraft engine having a guide vane segment. The guide vane segment included at least one hook at a shroud for fastening in the flow channel and connecting a plurality of guide vanes at a hook end has at least one cutout with the at least one cutout dividing the hook end along its lengthwise extension in the circumferential direction. In this way, a decambering effect of the guide vane segment is reduced advantageously during operation of the aircraft engine

### BACKGROUND OF THE INVENTION

The invention relates to a guide vane segment for a flow channel of an aircraft engine with a shroud, in particular for a compressor of an aircraft engine.

In a flow channel of compressors in an aircraft engine, guide vanes are used for diverting the flows. Here, the guide vanes are arranged between an inner housing and an outer housing. The outer housing also can be an intermediate housing and the flow channel can be a core flow channel of the aircraft engine. Here, the guide vanes are usually inserted individually in the housing or are inserted in a frame and then placed in the housing, whereby gaps are created through which leakages can occur. In order to minimize the leakage, a row of guide vanes can be combined by way of a common shroud to form a guide vane segment, so that the number of gaps is reduced. Inserted on the outer housing, the guide vane segment is secured in place against any displacement by a hook arrangement. During operation of the compressor, the guide vane segments are exposed to great temperature differences between an outer region and an interior of the flow channel. The temperature gradients thereby present during the operation of the aircraft engine lead to a decambering in the shroud of the guide vane segment, as a result of which, on the one hand, in an adjoining housing groove that accommodates the hook arrangement, an increased contact pressure can be created in some places and, on the other hand, the gaps that are present between the housing and the shroud as well as the hook arrangement can widen; however, the air gaps of the adjoining rotors and the outer housing can also widen.

This decambering effect poses a problem particularly for larger segments, because the mechanical distortions due to the thermal stresses arising between the ends of the shroud add up and are all the greater the further the segments extend in the circumferential direction. Therefore, the decambering of the shroud needs to be taken into account in designing the gaps, which, in a particularly detrimental manner in the region of the guide vane hooks and in the housing groove of the flow channel, leads to reinforcements and/or, in the design of the housing gaps, leads to larger gap dimensions, in particular also for the air gaps of the adjoining rotors.

### SUMMARY OF THE INVENTION

Therefore, it is an object of the invention to specify a guide vane segment that reduces at least in part or avoids the above-mentioned drawbacks. Furthermore, it is an object of the invention to specify an aircraft engine in which the above-mentioned drawbacks are reduced, at least in part, or are avoided.

The object is achieved by a guide vane segment and an aircraft engine using the guide vane segment of the present invention.

A guide vane segment according to the invention for a flow channel in a compressor of an aircraft engine comprises a row of guide vanes arranged in the circumferential direction and a shroud extending in the circumferential direction. The shroud connects the guide vanes in a vane root region, that is, in a radially outer region of the guide vanes, in the circumferential direction. In particular, the shroud can form a wall section of an inner wall of an outer housing of the flow channel. The shroud is designed for being fastened in the outer housing of the flow channel, with the shroud having a hook arrangement that extends in the circumferential direction and has at least one hook on an outer side of the shroud. In this way, the at least one hook can be insertable in a housing groove provided for this purpose in the outer housing. The shroud can be insertable in the housing groove in the circumferential direction and/or can create, together with the housing groove, a form fit that opposes any movement in the radial direction.

The object is solved in that the at least one hook has at least one cutout at an end of the hook, with the cutout dividing the hook end in the circumferential direction. The at least one cutout can divide the hook arrangement into hook sections. Owing to the at least one cutout, stresses within the hook are interrupted advantageously in the circumferential direction and the stiffness of the hooks is reduced in the circumferential direction, as a result of which the decambering is reduced advantageously. Deformations no longer add up, but rather arise instead locally in the hook sections that extend in the circumferential direction. Advantageously, the number of the cutouts can be greater than or equal to a number of vanes. In particular, the at least one cutout can extend transversely to a circumferential extension of the hook arrangement. The cutout can have an elongated extension, preferably in the axial direction or oblique to the axial direction, and, in particular, can pass through the hook completely in the radial direction. The hook end can extend in the axial direction parallel or nearly parallel to an engine axis and thereby have, in particular, a planar surface on its outer side and/or on its inner side, which is aligned parallel to the engine axis. Between the hook end and a hook base, it is possible to arrange a transition region that serves as a hook bend. The hook arrangement can have a rail-like design.

In the present description, an axial direction is defined as extending parallel to an engine axis, with a “front” being defined in the engine inlet and a “back” being defined in the engine outlet. Directions that extend perpendicular to the engine axis are defined as radial directions. The radial directions thereby extend from the inside at the engine axis towards the outside. Finally, the circumferential direction is defined as the direction around the engine axis. A radial direction and an axial direction together form the base of a meridional plane and its section that passes through the engine is defined as a meridional section. Cross sections that are formed in a meridional plane and extend in the circumferential direction give rise to a body that is curved in the circumferential direction.

Further advantages and features ensue from the following description of some preferred exemplary embodiments as well as the dependent claims.

In an advantageous embodiment of the guide vane segment according to the invention, the at least one hook can have a plurality of cutouts distributed in the circumferential direction at the hook end. The more cutouts are present, the smaller the action of the decambering effect on each individual hook section and thus advantageously on the entire hook arrangement.

In a further advantageous embodiment of the invention, it can be provided that the cutouts are arranged in uniform distribution in the circumferential direction. Owing to a uniform distribution of the cutouts in the circumferential direction, it is advantageously possible for the individual hook sections to be formed in a uniform manner, which simplifies the production thereof and thereby lowers the costs. The uniform distribution can also be limited to only one subsection of the hook arrangement, as a result of which, for example, at the ends, larger and/or smaller distances between two cutouts or between one cutout and a shroud front side or a front side of the hook arrangement can be provided. For the arrangement in the circumferential direction, the cutouts form a row of cutouts. Of the row of cutouts, only the inner cutouts of the row are arranged in uniform distribution. The row can have an end distance from the circumferential ends of the hook arrangement, with it being possible for the end distance to be different from a distance between two adjacent cutouts or all adjacent cutouts.

In an especially preferred further development, it can be provided that the hook is a first hook with a first hook end and that the hook arrangement has a second hook with a second hook end and that the second hook on the second hook end has at least one second cutout, with the at least one second cutout dividing the second hook end in the circumferential direction. Owing to the arrangement of cutouts on both sides of the hook arrangement, it is possible to divide up the structural component stresses especially effectively, so that the decambering effect is reduced advantageously still further. It can hereby be provided that the two hook ends of the first hook and of the second hook protrude in the axial direction in opposing directions, in particular cantilevering from a common platform. A surface of the platform can hereby be arranged further outward in the radial direction with respect to an edge to a front side of the shroud and/or with respect to an edge to a back side of the shroud. The platform can also be referred to as a hook shaft. Furthermore, it can be provided that the at least one cutout of the first hook and the at least one cutout of the second hook extend in the axial direction in opposing directions. This means that the cutouts divide their respective hook end and, if appropriate, the corresponding transition region from opposite directions. Especially preferably, a cutout of the first hook and a cutout of the second hook can be arranged in the circumferential direction in a common sectional plane, in particular in a common meridional section. The opposite-lying first and second cutouts can also be arranged offset with respect to one another, so that a flow of force can pass advantageously in an alternating manner through the hooks. The first hook can be a front hook and the second hook can be a back hook.

In a preferred supplemental or alternative further development of the invention, the at least one cutout can extend into an angled transition region of the hook between the hook end and a hook base. The transition region can be a cantilever that extends from the above-described platform, the hook end of which projects, in particular, in the axial direction. The hook base is arranged on a top side of the shroud and forms a connection between the hook arrangement and the remaining shroud that carries the guide vanes. The transition region can be angled with respect to an engine axis and preferably encompasses with the engine axis an angle a of 15° to 45°, in particular 20° to 40°, preferably 25° to 35°. If the hook arrangement has two hooks, then the two hooks can each have a transition region. If the hook arrangement has two hooks, then the respective transition regions can be arranged in a V-shaped arrangement. The first transition region of the first hook can hereby encompass with the engine axis an angle ai having a value that is different from an angle α₂, which is encompassed by the second transition region of the second hook with the engine axis. The two hooks can preferably extend in opposite directions.

In an especially preferred further development, the cutout in an end section facing away from the axial front side of the hook end can have a cross-section expansion, which, in particular, is a relief notch, transverse to a lengthwise extension of the cutout. The cross-section expansion can be followed in the lengthwise extension by a cross-section tapering. Owing to a cross-section expansion, the notch effect and accordingly the notch effect in the region of the front side of the hook end can be reduced advantageously.

The cutout can preferably be designed as a narrow slot, with a first end of the slot being situated on an axial front side of the hook end. The end section is opposite-lying to the first end of the cutout, in particular in the axial direction, in an inner region of the hook, with it preferably being possible for one end of the cutout to be arranged in a transition region.

In accordance with an embodiment, the cutout can be filled with a material that is softer than the material of the hook, in particular with a solder or with a plastic.

Especially preferably, the cross-section expansion can be a round hole extending in the radial direction, a square hole with rounded corners, and/or a rectangular hole with rounded corners. The cross-section expansion can hereby extend completely through the hook end or the transition region in the radial direction. A cross section of the cutout in the cross-section expansion on a surface of the hook can hereby extend completely in the radial direction through the hook. A round hole, in particular a circular or elliptical round hole, a square hole with rounded corners, and a rectangular hole with rounded corners are suitable especially well in an advantageous manner as a relief notch.

Beyond this, the cross-section expansion can be arranged in or at a kink and/or a bend between the hook end and a transition region of the hook. In this way, the notch effect of the cutout can be advantageously introduced specifically in the transition region. It can be provided, in particular, that the cross-section expansion is arranged, on the one hand, in a lengthwise extension of the cutout and in a surface projected in the radial direction or, on the other hand, in relation to a removed volume, in equal parts with respect to the kink or the bend. In this way, the notch effect is distributed especially favorably.

Alternatively, the cross-section expansion can adjoin a kink and/or a bend between the hook end and a transition region of the hook or can have a small distance to a kink and/or a bend between the hook end and a transition region of the hook of less than 5%, in particular 4%, preferably less than 3% of the lengthwise extension of the cutout.

In a special further development, it can be provided that the at least one cutout has a slot-shaped design. Advantageously, owing to the slot-shaped design of the cutout, only a small part of the hook is removed, so that, advantageously, the bearing capacity of the hook arrangement is hardly impaired, whereby, at the same time, the decambering effect is reduced. A first end of the slot can be situated on a front side of the hook end. The end section is opposite-lying to the first end of the cutout, in particular in the axial direction, preferably in the lengthwise direction of the cutout.

Alternatively or supplementally, the at least one cutout can divide the hook in the circumferential direction into at least two hook sections, with it being possible for a cross extension transverse to a lengthwise extension of the cutout, in relation to a cross-section expansion, to amount to between 2.5% and 7.5% of a circumferential extension of a hook section adjoining the cutout on the circumferential end side. Furthermore, alternatively or supplementally, a number of cutouts arranged in distribution in the circumferential direction can divide the hook into a number of hook sections increased by one, whereby a cross extension of the cutouts arranged in distribution transverse to a lengthwise extension of the respective cutouts can amount up to a cross-section expansion between 5% and 15% of a circumferential extension of a hook section that is bordered by two adjacent cutouts of the cutouts arranged in distribution. This likewise has the advantage that only a small part of the hook is removed, so that, advantageously, the bearing capacity of the hook arrangement is hardly impaired, while, at the same time, the decambering effect is reduced.

In a very advantageous further development of the guide vane segment, the hook end, in particular also a transition region of the at least one hook adjoining the hook end, can be surrounded by a friction plate, with the friction plate extending in the circumferential direction at least in sections over the at least one cutout. In an advantageous manner, on the one hand, a direct frictional contact between the hook is thereby prevented and, on the other hand, a leakage flow through the cutout is at least reduced. The friction plate can be designed as part of the hook arrangement and fastened in place to the hook in front of an insert in the housing groove. The friction plate can be joined to the hook in a meridional section in a form-fitting manner. In particular, the friction plate can have a cross section in a meridional section that is matched to a surface of the hook end and/or of the transition region for force-fitting attachment between the hook and the housing groove.

In a preferred embodiment, the friction plate can also be attached in a segment-spanning manner. That is, in a guide vane arrangement having a plurality of adjacently arranged guide vane clusters, the friction plate can cover at least two guide vane clusters and cover the gap at the point of abutment between the two clusters.

In an advantageous embodiment, the hook can have a first hook and the hook end can be a first hook end and the hook arrangement can have a second hook. The second hook can hereby have a second hook end and the second hook can have at least one cutout on the second hook end. Furthermore, the hook end of the first hook can be surrounded by a first friction plate and the hook end of the second hook can be surrounded by a second friction plate. In particular, it can hereby be provided that the first friction plate and the second friction plate are spaced apart from each other in the axial direction.

Supplementally, the first friction plate and the second friction plate can each cover completely the respective covered cutouts in the axial direction and/or in the circumferential direction. In this way, a leakage flow is advantageously reduced to a minimum.

In an especially preferred further development, in the case of two provided friction plates or at least one of the friction plates, the friction plate can have a thickness of between 0.1 mm and 0.5 mm, in particular between 0.2 mm and 0.4 mm, preferably between 0.25 mm and 0.35 mm, especially preferably 0.3 mm. Owing to such a thickness, an especially favorable compromise between adequate strength and a low weight is achieved. In addition, the friction plate can be easily adapted to the shape of the hook, so that an especially good sealing effect against a leakage flow is achieved. If two friction plates are provided, then they can have the same thickness. However, it can also be provided that one of the two friction plates is thicker than the other of the two friction plates. The thickness of the friction plates can vary within the specified ranges along an area extension of the friction plates. It can be provided that the first friction plate covers completely and/or both sides of the respective cutouts covered by the first friction plate. It can be provided that the second friction plate covers completely and/or both sides of the respective cutouts covered by the first friction plate.

A further aspect of the invention relates to an aircraft engine with a compressor of a flow channel, with the compressor having a guide vane segment, in particular in accordance with one of the preceding claims. The guide vane segment hereby has a row of guide vanes arranged in the circumferential direction and a shroud extending in the circumferential direction. Furthermore, the shroud connects the guide vanes in a vane root region in the circumferential direction, with the shroud being fastened in the outer housing of the flow channel. The shroud hereby has a hook arrangement that extends in the circumferential direction and has at least one hook on an outer side of the shroud, with the at least one hook being inserted in a housing groove provided for this purpose in the outer housing and with the housing groove creating a form fit that opposes any movement in the radial direction. The problem of the invention is solved in that the at least one hook has at least one cutout at a hook end, with the at least one cutout dividing the hook end along its lengthwise extension in the circumferential direction. In this way, a decambering effect of the shroud is reduced advantageously.

It can be provided that the cutout is arranged in the circumferential direction in a sectional plane, in particular in a meridional section, and is designed to be offset in the circumferential direction in relation to the vane leading edges of the guide vanes arranged next-nearest to the sectional plane. Alternatively or supplementally, it can be provided that the cutout is arranged in the circumferential direction in a sectional plane, in particular in a meridional section, between two vane leading edges of two adjacent guide vanes of the guide vanes. Alternatively or supplementally, the cutout can be arranged in the circumferential direction in a sectional plane, in particular in a meridional section, between a leading edge and a trailing edge of one guide vane of the guide vanes.

Beyond this, it can be provided that the shroud has an axial extension at a channel wall section, which, toward the front and/or toward the back, is designed to be larger, in particular by at least 10% larger, preferably by at least 12% larger, especially preferably by at least 14% larger, in particular by at least 16% larger, than an axial distance between a leading edge and a trailing edge of one of the guide vanes. In this way, it is advantageously possible to arrange a surface contouring on the surface of the channel wall section in front of and/or in back of the guide vanes.

### BRIEF DESCRIPTION OF THE DRAWING FIGURES

The invention will be explained in detail in regard to the following drawings on the basis of some preferred exemplary embodiments of the invention.

FIG. 1 shows in a schematic depiction an aircraft engine according to the invention with a first exemplary embodiment of a guide vane segment of a compressor according to the invention.

FIG. 2 shows the exemplary embodiment of the guide vane segment according to the invention with a friction plate in a perspective illustration.

FIG. 3 shows the exemplary embodiment of the guide vane segment according to the invention without the friction plate in a perspective illustration.

FIG. 4 shows a cutout of a hook end of the exemplary embodiment of the guide vane segment according to the invention in a radial plan view.

FIG. 5 shows the exemplary embodiment of the guide vane segment according to the invention in a housing groove of a flow channel of the aircraft engine according to the invention in a meridional section.

### DESCRIPTION OF THE INVENTION

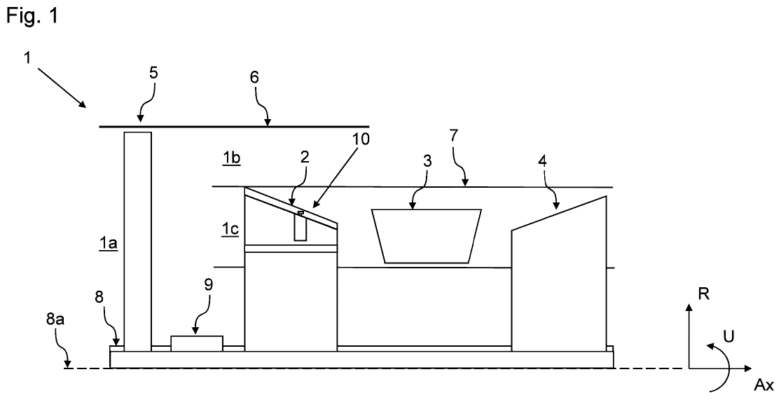

Depicted schematically in FIG. 1 is an aircraft engine 1 in a meridional section. The aircraft engine 1 has an engine inlet la, out of which a flow passes downstream to a secondary flow channel 1b and a flow channel 1c serving as a core flow channel 1c. The secondary flow channel 1b serves for the generation of thrust and the flow channel 1c serves primarily for the generation of energy for the components of the aircraft engine 1 and of cabin systems of an aircraft. Arranged in the flow channel 1c, sequentially in the flow direction, are the main components of the aircraft engine 1, namely, a compressor 2, a combustion chamber 3, and a turbine 4. The aircraft engine 1 has an engine outer housing 6 that surrounds the engine inlet la and the entire secondary flow channel 1b as well as an intermediate housing that separates the entire secondary flow channel 1b and the flow channel 1c, with the intermediate housing 7 serving as an outer housing 7 of the flow channel 1c. In the engine inlet 1a, a fan 5 having one fan stage or a plurality of fan stages can be arranged for the intake and initial compression of air. The fan 5 and the compressor 2 as well as the turbine 4 are coupled mechanically by at least one shaft 8 that rotates around an engine rotational axis 8a, with it being possible to decouple the fan 5 and, if appropriate, also the front low-pressure compressor stages (not depicted) from the more rapidly rotating turbine 4, in particular from a low-pressure turbine, by way of a gearbox 9. A portion of the air that is sucked in by the fan and compressed flows in the flow channel 1c, where it is strongly compressed by the compressor 2 in order to admix fuel in the combustion chamber 3 and ignite the mixture and finally expanded in the turbine 4 to drive the at least one shaft 8. The compressor 2 makes available compressed tapped air at tapped air sites for a tapped air system.

The engine rotational axis 8a serves as a reference axis for the definition of an axial direction Ax extending parallel to the engine rotational axis 8a, a radial direction R perpendicularly oriented with respect to it, and a circumferential direction U extending around the engine rotational axis 8a.

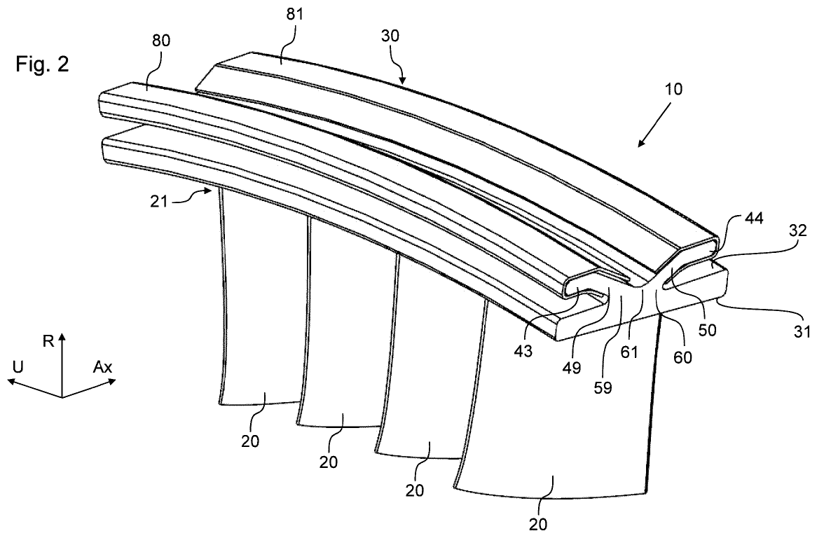

Owing to the high compression in the compressor 2, the temperature increases within the flow channel 1c, as a result of which high temperature gradients in the bordering channel walls ensue. In accordance with the invention, a guide vane segment 10 according to the invention, which is described in detail on the basis of an exemplary embodiment depicted in FIG. 2 to 5, is arranged in the compressor 2 of the aircraft engine 1 and can better withstand the temperature gradients, so that a decambering effect that usually arises in the case of such a shroud is reduced.

Shown in FIG. 2 in a perspective depiction is the exemplary embodiment of the guide vane segment 10 according to the invention with a friction plate 80. As illustrated, the guide vane segment 10 can have four guide vanes 20, which are connected in a vane root region 21 by way of a shroud 30 extending in the circumferential direction U.

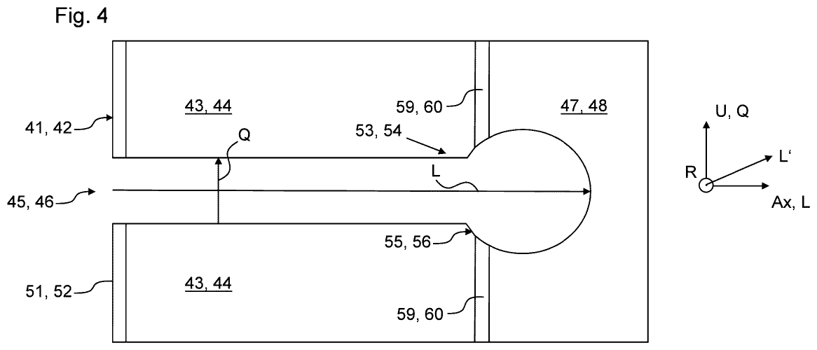

However, the shroud 30 can also connect more or fewer than four vanes, in particular five, preferably six, especially preferably seven, yet further preferably eight, yet further preferably nine, yet further preferably ten vanes 20 in the circumferential direction. The shroud 30 hereby forms, together with its radially inner-lying inner side 31, a channel wall section 31 of the flow channel 1c and, at its radially outer-lying outer side 32, has a hook arrangement 40 for fastening in a housing groove 71 of the outer housing 7 described in more detail in FIG. 4.

The hook arrangement 40 can have two hooks 41, 42, a first hook 41 with a first hook end 43 and a second hook 42 with a second hook end 44, with the hook ends 43, 44 pointing in the axial direction Ax in opposite directions. In particular, an inner surface and/or an outer surface of the first hook end and/or of the second hook end can extend parallel to a plane that is spanned by the axial direction Ax and the circumferential direction U and is curved in the circumferential direction U. In the present exemplary embodiment, a cross section formed through the hooks 41, 42 extends in the circumferential direction U.

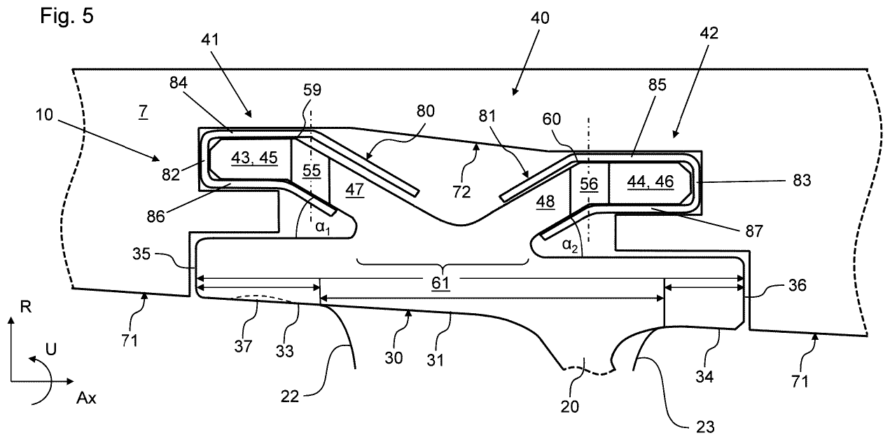

Adjoining the hook ends 43, 44, the hooks 41, 42 have a transition region 47, 48, which extends from the respective hook end 43, 44 to up to a first hook base 49 or up to a second hook base 50 of the respective hook 41, 42, with the hook arrangement 40 being integrally connected to the remaining shroud 30 by the hook bases 49, 50. The transition region 47, 48 hereby extends at an angle with respect to the axial direction Ax. The first transition region 47 encompasses with the axial direction Ax an angle α₁. The second transition region 48 encompasses with the axial direction Ax an angle α₂. In the present exemplary embodiment, the angle α₁ is 30°, but can also lie in a range between 20° and 40°, preferably in a range between 25° and 35°. In the present exemplary embodiment, the angle α₂ is 28°, but can also lie in a range between 20° and 40°, preferably in a range between 25° and 35°. For better clarity, the angles ai and az are depicted in a side view in FIG. 5.

The transition regions 47, 48 extend up to a respective hook base 49, 50 of the corresponding hook 41, 42, with it being possible for the hook bases 49, 50 to form a common platform 61, which is raised relative to the remaining shroud outer side 32 and hence a region of greater thickness of the shroud 30 can form. In this way, the weight of the vanes 20 and of the shroud 30 can advantageously be transferred very well onto the hooks 41, 42 and thus into the outer housing 7.

During operation, high temperatures arise in the flow channel 1c in comparison to the surroundings, so that, on account of the temperature gradients occurring in it, which bring about an outward distortion, the shroud 30 is decambered.

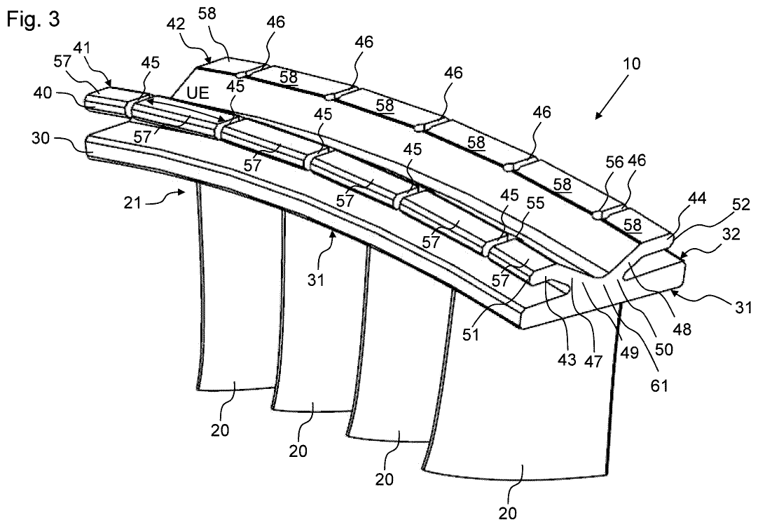

In order to counter this effect, the cutouts 45, 46, which are described in more detail on the basis of FIG. 3 to 5, are arranged in the hook ends 43, 44 and in a short section in the transition regions 49, 50. Friction plates 80, 81 extend over the cutouts and the hooks and are explained in more detail on the basis of a meridional section, depicted on the basis of FIG. 5, which passes through the guide vane segment 10 in the flow channel 7.

The cutouts 45, 46 subdivide the hook ends 45, 46 and the transition regions 49, 50 into a plurality of separated hook sections 57, 58 that extend in the circumferential direction U. On the one hand, the stresses in the hook sections 57, 58 are interrupted. On the other hand, the structural component stresses occurring in the circumferential direction are thereby conveyed into the hook base region, which, in particular, is reinforced and stiff, so that the decambering is reduced advantageously.

Arranged in the exemplary embodiment shown in FIG. 3 are five respective cutouts 45, 46, which are distributed in the circumferential direction U and each of the hook sections 57, 58 of which, formed between two adjacent cutouts, are designed to be of equal length. In each instance, one of the first cutouts 45 of the first hook 41 is hereby arranged further in the axial direction Ax relative to one of the second cutouts 46 of the second hook 42.

In order to reduce a notch effect of the cutouts 45, 46, the cutouts 45, 46 have a cross-section expansion 55, 56 in an end section 53, 54 facing away from the front side 51, 52 of the respective hook end 43, 44, the cross extension Q of which initially increases transversely to a lengthwise extension L of the cutout 45, 46. The cross extension can, in particular, initially increase along the lengthwise extension L in the end section 53, 54 and then decrease and preferably be reduced to zero at an end of the lengthwise extension L. In the present exemplary embodiment, the cross-section expansion has a circular cross section as viewed in the radial direction R. However, it can also be designed with rounded corners in a square or rectangular manner, for instance.

FIG. 4 shows an embodiment of a cutout 45, 46 in a plan view. The cutout 45, 46 can be one of the first cutouts 45 or one of the second cutouts 46 that are shown in the hooks 41, 42 in FIG. 3. In the case of a second cutout 46, the depicted cutout would be assumed to be a mirror image. The lengthwise extension L of the cutout 45, 46 extends from a front side 51, 52 of the hook end 43, 44 up to an end of an end section 53, 54 of the cutout 45, 46 lying opposite the front side 51, 52. The cutout 45, 46 extends in the hook end 43, 44 in a slot shape, that is, with a larger lengthwise extension L than the cross extension Q, up to just before a bend in the surface 59, 60 of the hook 41, 42 arranged between the corresponding hook end 43, 44 and the transition region 47, 48. Instead of a bend 59, 60, a kink can also be formed between the hook end 43, 44 and the transition region 47, 48. Following the slot-shaped section of the cutout 45, 46 in the lengthwise direction L is a cross-section expansion 55, 56 formed as a relief notch. Owing to the cross-section expansion 55, 56, the increased stress within the hook 41, 42 on account of the notch effect of the cutout 45, 46 is at least partially reduced advantageously. The cross-section expansion has a circular cross section, as shown in FIG. 3. However, it can also be a square or right-angled cross section with rounded corners or have an elliptical shape or a free-formed shape.

In the shown exemplary embodiment, the lengthwise extension L extends parallel to the engine axis 8a and thus parallel to the axial direction Ax. Alternatively, it can be provided that the lengthwise direction L′ of the cutout 45, 46—as shown in the coordinate system on the right in FIG. 4—e xtends obliquely to the axial direction Ax.

Depicted in FIG. 5 is the embodiment of the guide vane segment 10 according to the invention 10 shown in FIGS. 2 and 3 with the hook arrangement 40 in a housing groove 72 of an inner wall 71 of the intermediate housing 7. The inner wall 71 of the intermediate housing 7 and the inner side 3,1 formed as a channel wall section 31, of the shroud 30 form together an outer section of the flow channel 1c.

In the gap between the hook arrangement 40 and the housing groove 72, a first friction plate 80 is arranged around the first hook 41 and a second friction plate 81 is arranged around the second hook 42. The friction plates 80, 81 hereby each surround completely the corresponding hook end 43, 44 and extend up to over the transition region, covering the respective transition region 47, 48. A respective middle sheet metal section 82, 83 of the corresponding friction plates 80, 81 hereby rests against the respective front side of the respective hook end 43, 44 and closes the gap between the corresponding hook 41, 42 and the housing groove 72. A respective outer sheet metal section 84, 85 extends from the hook end 43, 44 up to over the transition region 47, 48 and hereby follows the contour of the hook end 43, 44 and of the transition region 47, 48 and covers completely the cutout 45, 46 at its radial top side. It can also be provided that the outer sheet metal section 84, 84 rests against the top side of the hook 45, 46 completely along its extension in a meridional plane.

A respective inner sheet metal section 86, 87 extends from the hook end 43, 44 up to under the transition region 47, 48, hereby follows the contour of the hook end 43, 44 and of the transition region 47, 48 and covers the cutout 45, 46 and, in particular, in the present exemplary embodiment, also the cross-section expansion 55, 56 at its radial bottom site and hereby also rests completely against the bottom side of the hook 41, 42. This has the advantage that the cutout is closed completely, so that a leakage flow is prevented and nonetheless a decambering effect is reduced by the cutouts 41, 42.

It can be seen further in FIG. 5 that the channel wall section 31 has a front axial projection 33 and a back axial projection 34 with respect to the guide vanes 20. The channel wall section 31 with at least one axial projection 33, 34 has a markedly larger axial extension between a front face side 35 and a back face side 36 of the channel wall section 31 than the guide vanes 20, which extend from the channel wall section 31 in the radial direction R, between their leading edge 22 and their trailing edge 23 in the vane root region 21. A possibly produced fillet is hereby taken into consideration as well. At the corresponding, at least one axial projection 33, 34, therefore, it is possible to form advantageously a cross-hatched depicted surface contouring 37 for improvement of the flow conduct.

1. A guide vane segment for a flow channel in a compressor of an aircraft engine comprising:
a row of guide vanes arranged in the circumferential direction and
a shroud extending in the circumferential direction,
with the shroud connecting the guide vanes in a vane root region in the circumferential direction,
with the shroud being designed for being fastened in an outer housing of the flow channel,
with the shroud having a hook arrangement that extends in the circumferential direction and having at least one hook on an outer side of the shroud,
wherein at least one hook has at least one cutout on a hook end with the at least one cutout dividing the hook end along its lengthwise extension in the circumferential direction.

2. The guide vane segment according to claim 1, wherein the at least one hook has a plurality of cutouts at the hook end distributed in the circumferential direction.

3. The guide vane segment according to claim 2, wherein the cutouts are arranged in uniform distribution in the circumferential direction.

4. The guide vane segment according to claim 1, wherein the hook is a first hook with a first hook end and the hook arrangement has a second hook with a second hook end wherein the second hook has at least one cutout on the second hook end and wherein the at least one second cutout divides the second hook end along its lengthwise extension in the circumferential direction.

5. The guide vane segment according to claim 1, wherein the at least one cutout extends in an angled transition region of the hook between the hook end and a hook base.

6. The guide vane segment according to claim 1, wherein the at least one cutout has a cross-section expansion in an end section facing away from an axial front side of the hook end which, is a relief notch, transverse to a lengthwise extension of the cutout.

7. The guide vane segment according to claim 6, wherein the cross-section expansion is a round hole extending in the radial direction a square hole with rounded corners, and/or a rectangular hole with rounded corners.

8. The guide vane segment according to claim 6, wherein the cross-section expansion is arranged in or on a kink and/or a bend between the hook end and a transition region of the hook.

9. The guide vane segment according to claim 1, wherein
the at least one cutout has slot-shaped design and/or
the at least one cutout divides the hook in the circumferential direction into at least two hook sections and in that a crosswise extension transverse to a lengthwise extension of the cutout up to a cross-section expansion makes up between 2.5% and 7.5% of a circumferential extension of a circumference-side hook section adjoining the cutout, and/or
a number of cutouts arranged distributed in the circumferential direction divides the hooks into a number increased by one of hook sections and in that a cross extension of the cutouts in distributed arrangement transverse to a lengthwise extension of the respective cutouts up to a cross-section expansion makes up between 5% and 15% of a circumferential extension of a hook section that is bordered by two adjacent cutouts in distributed arrangement.

10. The guide vane segment according to claim 1, wherein the hook end of the at least one hook is surrounded by a first friction plate and a second friction plate, which extend in the circumferential direction at least in sections over the at least one cutout

11. The guide vane arrangement according to claim 1, wherein
the hook is a first hook with a first hook end and in that the hook arrangement has a second hook with a second hook end with the second hook having at least one cutout on the second hook end and
the first hook end of the first hook is surrounded by a first friction plate and
in that the second hook end of the second hook is surrounded by a second friction plate.

12. The guide vane segment according to claim 10, wherein the first friction plate and the second friction plate have a thickness of between 0.1 mm and 0.5 mm, in particular between 0.2 mm and 0.4 mm, preferably between 0.25 mm and 0.35 mm, especially preferred 0.3 mm.

13. The guide vane segment according to claim 1, wherein the shroud has an axial extension at a channel wall section which towards the front and/or towards the back in the axial direction is configured and arranged to be at least about 10% larger, than an axial distance between a leading edge and a trailing edge of one of the guide vanes.

14. An aircraft engine with a compressor of a flow channel wherein the compressor has a guide vane segment according to claim 1, wherein
the guide vane segment has a row of guide vanes arranged in the circumferential direction, and
the guide vane segment has a shroud extending in the circumferential direction,
the shroud connects the guide vanes in a vane root region in the circumferential direction,
the shroud being fastened in the outer housing of the flow channel,
the shroud has a hook arrangement extending in the circumferential direction with at least one hook on an outer side of the shroud,
with the at least one hook being inserted in a housing groove in the outer housing and, together with the housing groove, being configured and arranged to provide a form fit opposing any movement in the radial direction,
wherein the at least one hook has at least one cutout at a hook end with the at least one cutout dividing the hook end along its lengthwise extension in the circumferential direction.
